(19) United States
(12) Patent Application Publication
(10) Pub. No.: US 2011/0295691 A1
(43) Pub. Date: Dec. 1, 2011

(54) RADIO RECEIVER BASED GREETING CARD SYSTEM

(76) Inventor: Marcus Krieter, Newport Beach, CA (US)

(21) Appl. No.: 12/789,261

(22) Filed: May 27, 2010

(51) Int. Cl. G06Q 30/00; G01C 21/32; G01C 21/34

(52) U.S. Cl. 705/14.58; 701/209; 701/211

(57) ABSTRACT

A method and system for providing location-based advertising and location-based greeting through a radio receiver based greeting is disclosed. The system for providing location-based advertising comprises a greeting card having at least one surface, a radio receiver coupled to the surface, an information module coupled to the radio receiver, and a power source coupled to at least one of the radio receiver and the information module.

### FIELD OF INVENTION

The invention relates to greeting cards and advertising materials, and more particularly, to greeting cards having radio receiver capabilities and utilized for advertisement of any brand or for celebrations purposes.

### BACKGROUND

Greeting cards and advertising materials are often provided for varied purposes. Greeting cards are used for celebrating occasions, and, advertising materials such as premiums, advertisement, promotions, coupons and the like are used to promote various goods and services. Premiums usually represent commercial gifts or souvenirs provided by commercial entities, such as a fast food restaurant to potential customers as part of promotion of their product lines, services, locations, and the like.

The greeting cards have traditionally been distributed in the form of printed publication. Furthermore, premiums are distributed in the form of any article such as promotional products, mementos, and the like, related to a particular brand.

Traditionally, greeting cards and premiums have been passive means for advertisements. Once the advertising party delivers the greeting cards and the premiums to the potential customers, the advertising party do not remain in contact with the customers. Further, traditional greeting cards include static pages with content printed thereupon. Similarly, the premiums may be articles having advertising materials written or engraved thereupon. Additionally, these greeting cards and premiums do not have any special features apart from the content that may arouse interest or generate curiosity in the brand or product from the potential customers of the greeting cards and premiums. Such static pages of the greeting cards or premiums generally do not appeal to the recipients, and recipients may lose interest in such static pages after an initial viewing.

Based on the foregoing, there is a need for providing a greeting system that may enhance the interest of the recipient towards the promotion of any brand or celebration of any occasion.

### BRIEF SUMMARY OF THE INVENTION

An object of the present invention is to provide a greeting system utilized to celebrate an occasion or promotion of a brand.

Another object of the present invention is to provide a greeting system that enhances the interest of a recipient towards a brand to be promoted.

To achieve the objects of the present invention, an embodiment of the present invention provides a system for providing location-based advertising. The system comprises a greeting card having at least one surface, a radio receiver coupled to the surface, an information module coupled to the radio receiver, and a power source coupled to at least one of the radio receiver and the information module.

In another embodiment of the present invention, a method for providing location-based advertising is disclosed. The method comprises the steps of transmitting a first location coordinate and an identifier from a radio receiver on a greeting card to a Global Positioning System (GPS), determining a second location coordinate based on the identifier at the GPS, computing a route between the first location coordinate and the second location coordinate, transmitting the route from the GPS to the radio receiver, and displaying the route on a display on the greeting card.

In yet another embodiment of the present invention, a system for providing location-based greeting is disclosed. The system comprises a greeting card having a flexible display screen, a Global Positioning System (GPS) receiver coupled to the greeting card and communicatively coupled to the GPS, a power source coupled to the GPS receiver, and a speaker configured to the greeting card and configured to emit an audible message.

In another embodiment, a method for providing location-based advertising, comprising the steps of: transmitting to a Global Positioning System (GPS), via a radio receiver on a greeting card, a first location coordinate and an identifier; determining, at the GPS, a second location coordinate based on the identifier; computing, at the GPS, a route between the first location coordinate and the second location coordinate; transmitting to the radio receiver, from the GPS, the route; and displaying the route on a display on the greeting card.

### BRIEF DESCRIPTION OF THE DRAWINGS

The preferred embodiments of the invention will hereinafter be described in conjunction with the Figure provided herein to further illustrate various non-limiting embodiments of the invention, wherein like designations denote like elements, and in which:

FIG. 1 depicts an environment including a system of providing location-based advertising, in accordance with an embodiment of the present invention.

FIG. 2 illustrates a system for providing location-based greeting, in accordance with an embodiment of the present invention.

FIG. 3 illustrates a flexible display screen displaying a promotional message, in accordance with an exemplary embodiment of the present invention.

FIG. 4 illustrates a flexible display screen displaying a map route to reach a commercial outlet from one or more locations, in accordance with an exemplary embodiment of the present invention.

FIG. 5 illustrates a flow diagram of a method of providing location-based advertising, in accordance with an embodiment of the present invention.

FIG. 6 illustrates a premium in the form of a coffee-mug for providing location-based advertising, in accordance with an embodiment of the present invention.

### DETAILED DESCRIPTION OF THE EMBODIMENTS

In the following detailed description of the embodiments of the invention, numerous specific details are set forth in order to provide a thorough understanding of the embodiments of the invention. However, it will be obvious to one skilled in the art that the embodiments of the invention may be practiced without these specific details. In other instances well known methods, procedures, components, and circuits have not been described in detail so as not to unnecessarily obscure aspects of the embodiments of the invention.

Furthermore, it will be clear that the invention is not limited to theses embodiments only. Numerous modifications, changes, variations, substitutions and equivalents will be apparent to those skilled in the art without parting from the spirit and scope of the invention.

The embodiments of the invention include a radio receiver based greeting card system utilized for celebration of an occasion and for arousing interest or generating curiosity in the brand or product from the potential customers of the greeting card system.

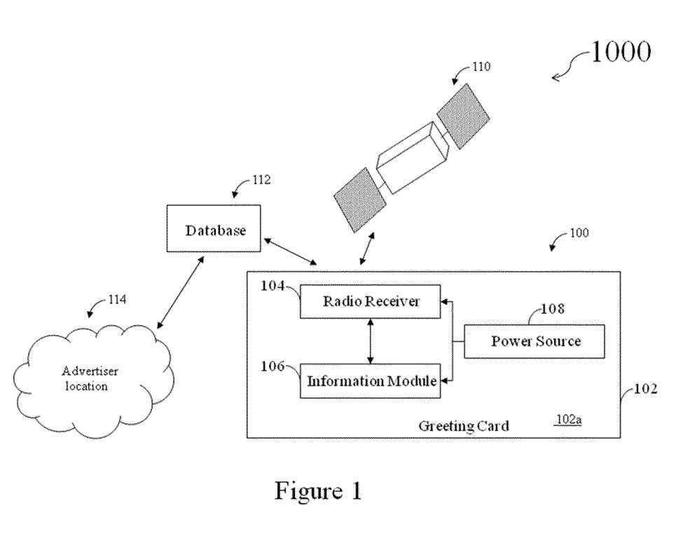

Referring to FIG. 1, an environment 1000 including a system 100 of providing location-based advertising is disclosed, in accordance with an embodiment of the present invention. The environment 1000 depicts the system 100, a Global Positioning System (GPS) 110 (depicted in FIG. 1 in the form of a GPS satellite), a database 112 and a remote advertiser location 114.

The system 100 includes a greeting card 102, a radio receiver 104, an information module 106 and a power source 108. In FIG. 1, the greeting card 102 is depicted as a block, however, it will be evident to a person skilled in the art that the greeting card 102 may be a typical greeting card with two page layout and four displayable surfaces. The greeting card 102 includes at least one surface, such as surface 102a. The radio receiver 104 is coupled to the surface 102a. It will be obvious to a person skilled in the art that though the radio receiver 104 is depicted to be coupled to the surface 102a, it may be coupled to any surface of the greeting card 102, such as a front surface, a rear surface or may be placed within a page of the greeting card 102, such as being sandwiched together within the page. Further, it will be evident to those skilled in the art requisite arrangements may be provided to couple the radio receiver 104 to the surface 102a. Examples of arrangements may include fastening arrangements known in the art, such as a hook and loop fastener or even a Velcro arrangement.

In an embodiment of the present invention, the radio receiver 104 is a Wireless Fidelity (Wi-Fi) receiver. In another embodiment, the radio receiver 104 is a Bluetooth receiver or RFID receiver. The radio receiver 104 may be a thin receiver that is coupled to the surface 102a. The radio receiver 104 may be as thin as existing sound cards used in electronic devices. In another embodiment, the radio receiver 104 is a Global positioning System (GPS) receiver. The GPS receiver may detect location information, i.e. a geographical position of the system 100.

Once the system 100 is in range of a commercial outlet, such as the advertiser location 114, the radio receiver 104 may receive radio frequency signal corresponding to at least one of a greeting message and a promotional message for a product brand. An example of an advertiser location 114 may be a restaurant, a coffee house, a commercial outlet and the like. Greeting message and the promotional message may be pre-recorded by an advertiser and stored on a remote server, such as database 112, coupled to the radio receiver 104. The database 112 may serve as a repository of greeting messages and promotional messages and may provide pre-recorded promotional messages to the radio receiver 104 based on criteria, such as nature of occasion, time of the year or even time of the day and the like.

The information module 106 is coupled to the radio receiver 104, i.e. the information module 106 receives its input from the radio receiver 104. It will be evident to those skilled in the art that requisite electrical connections may be provided for coupling the information module 106 to the radio receiver 104.

In an embodiment, the information module 106 is a flexible display screen. In one embodiment, the information module 106 in the form of a flexible display screen is configured to display a promotional message. In one specific embodiment, the flexible display screen may include the capability of an electronic ink (“e-Ink”) display or such other zero-power or low-power display. Promotional messages may be displayed using e-ink to invite the recipient of the system 100 to go to a particular location (restaurant, hotel, party, etc.) where they may receive another message, product, or promotion, or learn more about a particular advertiser's goods and services. This would create interest in the recipient, as the recipient would not be able to unlock the remaining content of the greeting card 102, unless the recipient of the system 100 visits the location to collect the complete greeting card 102.

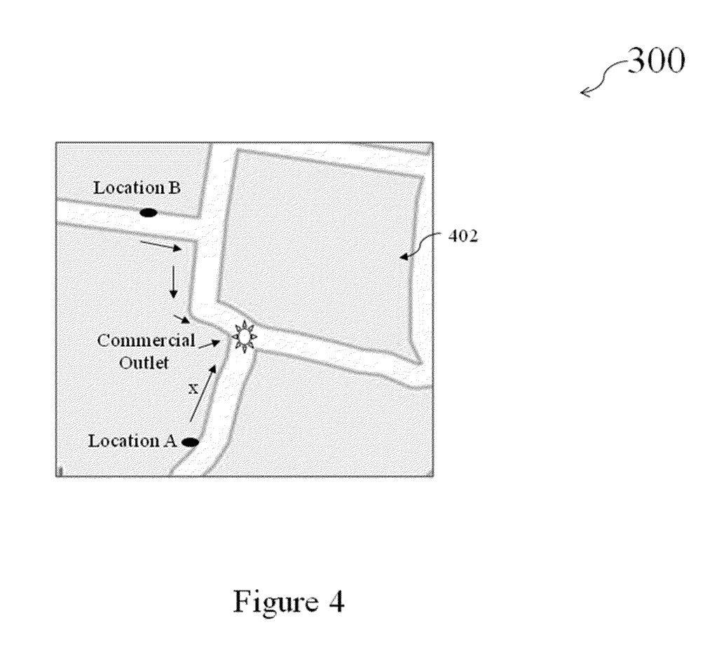

In one embodiment, a map of the location may also be displayed on the flexible display screen to assist the recipient to reach to the location. In an embodiment, the recipient can see on the flexible display screen their current location in relation to the destination. The display of map on the flexible display screen will be explained in further detail in conjunction with FIG. 4.

In another embodiment, the information module 106 is a speaker. In one embodiment, the speaker is configured to emit an audible promotional message. The promotional message may be provided to the recipient of the system 100 when the recipient is in the vicinity of the advertiser's location, such as the advertiser location 114. In one embodiment, the audible promotional message may be a preset audio tune. For example, the information module 106 may play a preset message to the recipient of the system 100 indicating the recipient to visit a nearby commercial location of a brand. The information module 106 may also play a message or a preset jingle indicating that the recipient proceeds for a particular location to collect a promotional material, such as an additional gift article. For example, the recipient may be informed to go to a particular location to collect air tickets as promotional offers from an airline service. Accordingly, the system 100 creates interest in the recipient as the recipient is informed to collect the complete greeting card 102 by reaching at a particular location.

In yet another embodiment, the information module 106 includes a flexible display screen and a speaker. The flexible display screen and the speaker provide the promotional message to the recipient of the system 100.

In another embodiment, the information module 106 may include a logo or trademark that may be disposed on the greeting card 102. If the radio receiver 104 receives any relevant radio signal, the logo may change its color, shape, text, or form depending upon the received radio signal. It would be apparent to those of ordinary skill in the art that the logo would change its color when the system comes in the vicinity of the advertising company. In another embodiment, the logo may also change its color at a particular time of the day or time slot. Accordingly, the system 100 having radio receiver 104 such as the GPS receiver or a Wi-Fi receiver may activate the audio message and/or e-Ink display, thereby changing the display, or change the color of the logo based on the geographical location and time.

The system 100 further includes the power source 108 that is electrically coupled to at least one of the radio receiver 104 and the information module 106. The power source 108 may be a thin battery. In one embodiment, the power source 108 may be a photovoltaic cell. In another embodiment, the power source 108 may be a rechargeable battery. In yet another embodiment, the power source 108 may be a solar cell or panel affixed to a surface, such as the surface 102a, of the greeting card 102.

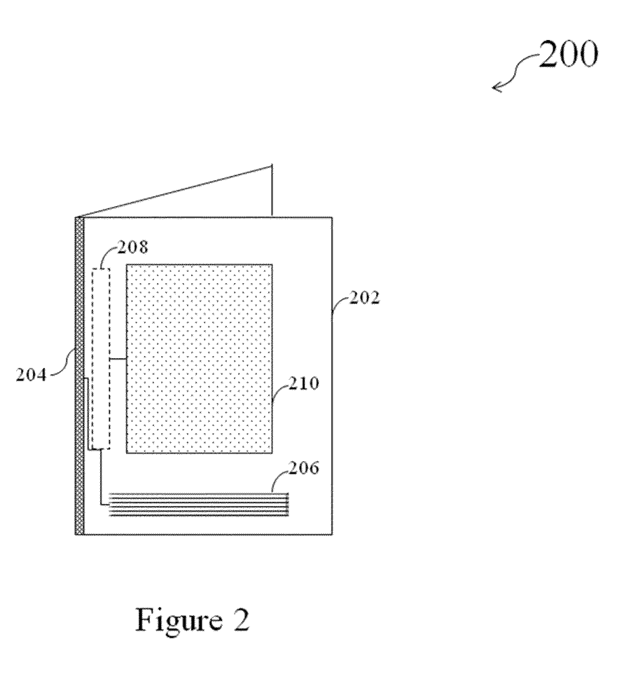

Thus, as explained in conjunction with FIG. 1, the system 100 provides location-based advertising that enhances the interest of a recipient towards a brand to be promoted. The provision of location-based greeting is explained in conjunction with FIG. 2.

FIG. 2 depicts a system 200 of providing location-based greeting, in accordance with an embodiment of the present invention. The system 200 includes a greeting card 202, a GPS receiver 204 coupled to the greeting card 202 and communicatively coupled to a GPS (such as GPS satellite 110 of FIG. 1 and not shown in FIG. 2), a speaker 206 coupled to the greeting card 202 and configured to emit an audible message, and a power source 208 coupled to the GPS receiver 204 and the speaker 206.

The greeting card 202 further includes a flexible display screen 210. The flexible display screen 210 is depicted to be coupled to the power source 208. It will be evident to those skilled in the art that requisite electrical connections may be provided to couple the power source 208, to the GPS receiver 204, the speaker 206, and the flexible display screen 210.

The greeting card 202, the GPS receiver 204, and the power source 208 are similar in all features to the greeting card 102, the radio receiver 104, and the power source 108 respectively, and are not explained herein for sake of brevity of description. Further, the flexible display screen 210 and the speaker 208 perform functions similar to the flexible display screen and the speaker explained in conjunction with FIG. 1.

In one embodiment, the flexible display screen 210 is configured to display a video message. In another embodiment, the video message may be based on a signal received from the GPS receiver 204. In one embodiment, the flexible display screen 210 may be configured to display location information of the greeting card 202. The GPS receiver 204 may provide the location information to the flexible display screen 210 for display purposes.

Further, as explained in conjunction with FIG. 1, the flexible display screen 210 may include the capability of an e-Ink display or such other zero-power or low-power display. Greeting messages may be displayed using e-ink to invite the recipient of the system 200 to go to a particular location (restaurant, hotel, party, etc.) where they may receive another gift. This would create interest in the recipient, as the recipient would not be able to unlock the remaining content of the greeting card 202, unless the recipient of the system 200 visits the location to collect the complete greeting card 202.

In one embodiment, a map of the location (for receiving the gift) may also be displayed on the flexible display screen 210 to assist the recipient to reach to the location from the current location information.

As explained earlier, the flexible display screen 210 may be an e-Ink display. The e-Ink display may be configured to change automatically with changes in the geographical location and time. For example, the greeting card 102 may be in form of a story book provided by a publishing house, and the story of the story book can change with changes in geographical location and the time.

In one embodiment, when the recipient of the greeting card 202 comes in the range of any outlet of the brand, the GPS receiver 204 may receive the radio signals propagated from the outlet or the establishment of the brand. Further, a preset message may be played or displayed through e-Ink on the flexible display screen 210 about the nearest brand outlet. The recipient may visit the nearest brand outlet to collect the complete greeting card 202.

Thus, triggers such as geographical location and time may be used to unlock features in the system 200. More specifically, based on the geographical location and the time, the recipient of the system 200 may be informed to visit to a particular location to unlock or collect the complete features of the greeting card 202. However, the scope of the present invention is not limited to only geographical location and the time. In addition to the geographical location and the time, other triggers may also be used to unlock features in the system 200. Such additional triggers may include things changes in the light, date, holidays, and changes in seasons, weather patterns, noise levels, and temperature.

For example, the recipient of system 200 may be asked to open the greeting card 202 when the light becomes dim. Accordingly, the recipient may listen to a bedtime story when the recipient opens the greeting card 202 in a dim light. Similarly, the speaker 206 may play a different greeting message on every day of ‘Hanukkah’. Other examples of the trigger may include, but are not limited to, accelerometers, electronic compass, voice recognition, RF Wi-Fi detection, and the like.

In one embodiment, the audible message emitted by the speaker 206 is a promotional message. The promotional message may be provided to the recipient of the system 200 when the recipient is in vicinity of the advertiser's location, such as the advertiser location 114. In one embodiment, the audible message is based on a signal received from the GPS.

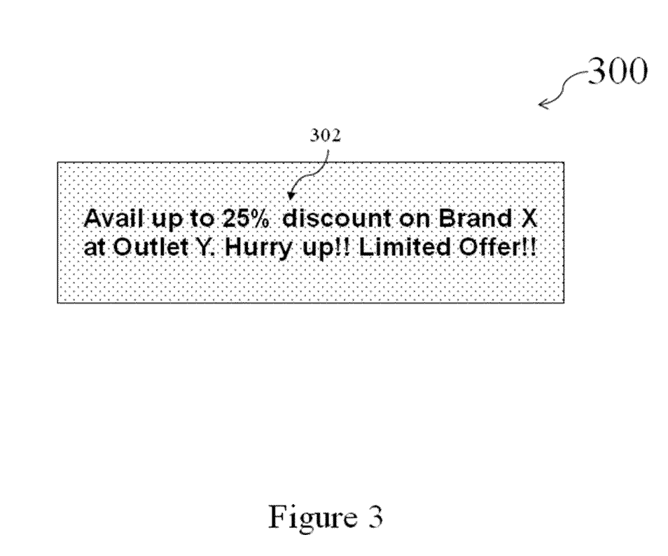

Thus, the system 200 may be configured to provide location-based greeting as well as location-based advertising. The greetings or the promotional messages may be displayed on the flexible display screen 210. An exemplary flexible display screen displaying a promotional message is depicted in FIG. 3.

FIG. 3 illustrates a flexible display screen 300 displaying a promotional message 302, in accordance with an exemplary embodiment of the present invention. The flexible display screen 300 is similar to the flexible display screen 210 explained in conjunction with FIG. 2.

As explained in conjunction with FIGS. 1 and 2, the flexible display screen 300 may be coupled to a greeting card, such as greeting card 202. The flexible display screen 300 may be configured to display a variety of greetings and promotional messages. One such promotional message including the text “Avail up to 25% discount on Brand X at Outlet Y. Hurry up!! Limited Offer!!”. It will be evident to those skilled in the art that promotional message 302 is depicted herein for exemplary purposes and various such promotional messages or greetings may be displayed on flexible display screen 300.

Further, as explained in conjunction with FIGS. 1 and 2, the promotional messages or greetings may be triggered based on location of the greeting card. Furthermore, in addition to displaying the promotional messages, such as promotional message 302, the flexible display screen 300 may display a map for reaching a commercial outlet from his/her current location for availing promotional offers. One such display of a map on the flexible display screen 300 is depicted in FIG. 4.

FIG. 4 illustrates the flexible display screen 300 displaying a map route 402 to reach a commercial outlet from one or more locations, in accordance with an exemplary embodiment of the present invention. As explained in conjunction with FIG. 3, promotional messages or greetings may be displayed on the flexible display screen 300 based on location of the greeting card (coupled to the flexible display screen 300 and not shown in FIG. 4). In addition to displaying the promotional messages, such as promotional message 302 of FIG. 3, the flexible display screen 300 may display a map route, such as the map route 402, for reaching the commercial outlet from his/her current location, such as location A, or from any other desired location, such as location B, for availing the promotional offers. A recipient of the greeting card including the flexible display screen 300 may then follow the map route for reaching the commercial outlet and availing the promotional offers.

In an embodiment, the flexible display screen 300 may be coupled to a GPS receiver, such as the GPS receiver 204, for receiving the location information and for displaying the map-route. In an embodiment, the flexible display screen 300 may display directions instead of map-route 402 for guiding the recipient of the greeting card to reach the commercial outlet.

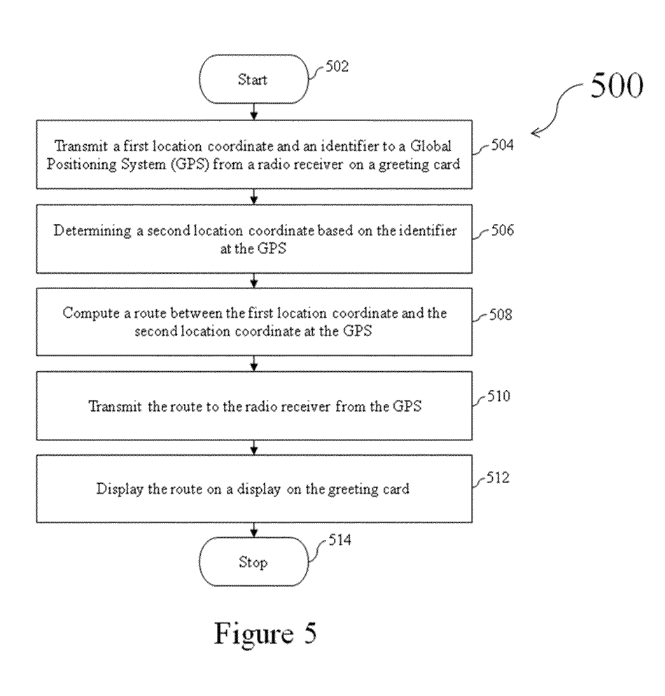

In an embodiment, the flexible display screen 300 may be coupled to a speaker, such as the speaker 206, for emitting audible promotional messages and even directions for reaching the commercial outlet. Thus, the flexible display screen 300 may be utilized for displaying location-based greeting and location-based advertising. A method of providing location-based advertising is explained in conjunction with FIG. 5.

FIG. 5 illustrates a flow diagram of a method 500 of providing location-based advertising, in accordance with an embodiment of the present invention. The method 500 starts at step 502. At 502, a first location coordinate and an identifier is transmitted to a Global Positioning System (GPS) from a radio receiver on a greeting card. At 504, a second location coordinate is determined based on the identifier at the GPS. At 506, a route between the first location coordinate and the second location coordinate is computed at the GPS. At 508, the route is transmitted to the radio receiver from the GPS. At 510, the route is displayed on a display on the greeting card. The method ends at 512. It may be obvious to a person skilled in the art, that the radio receiver may be a GPS receiver.

The greeting card and the radio receiver are similar to the greeting card 202 and the GPS receiver 204, and, are not explained herein for sake of brevity of description. The display on the greeting card is similar to the flexible display screen 210 and is not explained herein.

In an embodiment, the first location coordinate is coordinate information of a current location of the greeting card, and, an identifier is information related to a desired destination, such as a commercial outlet of FIG. 4. The GPS may then determine the second location coordinate, i.e. the coordinate information of the desired destination. The GPS may further determine a route, such as a map-route 402 of FIG. 4, from the first location coordinate to the second location coordinate and may transmit the route, such as the map route 402 displayed on the flexible display screen 300, for display on the greeting card. In an embodiment, the method 500 may further include the step of continually receiving an updated route from the GPS.

In an embodiment, a message is displayed on the display when the radio receiver, i.e. the recipient of the greeting card, is in the vicinity of the second location coordinate. In an embodiment, the message is a promotional message. In an embodiment, the message is a greeting. In one embodiment, an audible message is played when the radio receiver, i.e. the recipient of the greeting card, is in the vicinity of the second location coordinate. In an embodiment, the audible message is a promotional message. In an embodiment the audible message is a greeting. Thus, the method 500 may be utilized for providing location-base advertising and/or location-based greeting to the recipient of the greeting card.

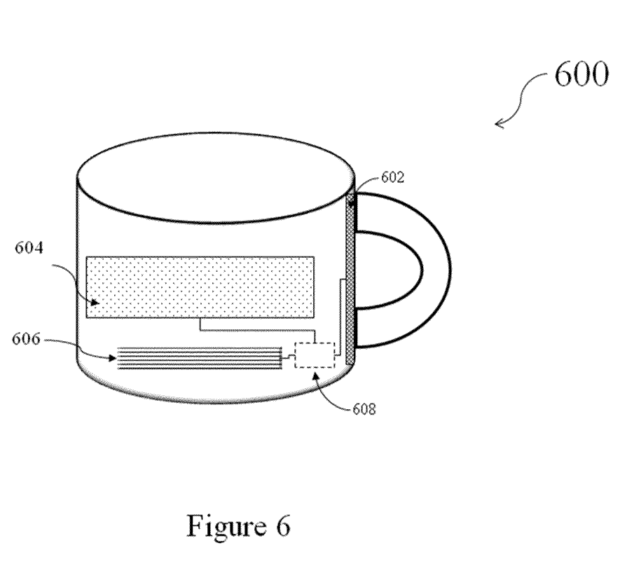

The location-based advertising and/or location-based greeting may not be limited to greeting cards as explained in FIGS. 1 to 5. Gift articles, such as coffee-mugs, charms or mementos, or even promotional articles, like pen, notebook, stationary, paper weight, may be utilized for providing location-based advertising. A coffee-mug for providing location-based advertising is displayed in FIG. 6.

FIG. 6 illustrates a premium in form of a coffee-mug 600 for providing location-based advertising, in accordance with an embodiment of the present invention. Premiums usually represent commercial gifts or souvenirs provided by commercial entities, such as a fast food restaurant to potential customers as part of promotion of their product lines, services, locations, and the like. The coffee-mug 600 includes elements like those coupled to the greeting card like a GPS receiver 602, such as the GPS receiver 204, a flexible display screen 604, such as the flexible display screen 210, a power source 606, such as the power source 208 and a speaker 206, such as the speaker 210 of FIG. 2. The components of the coffee-mug such as the GPS receiver 602, the flexible display screen 604, the power source 606 and the speaker 610 perform functions as explained above for related components and are not explained herein for sake of brevity of description.

The GPS receiver 604 coupled to the flexible display screen 606 may be utilized for identifying a current location of the coffee-mug, (i.e. a location of the user of the coffee-mug) and accordingly, location-based advertising in form of promotional messages and/or location based greeting may be provided for display on the flexible display screen 606. Further, the speaker may be configured to emit audible messages which may be promotional messages or greetings.

In an embodiment, the coffee-mug may be provided at a restaurant serving coffee to potential customers, and, the flexible display screen 606 may be configured to depict a logo of the restaurant or even promotional offers at the restaurant, when the coffee-mug 600 is in vicinity of the restaurant (i.e. a transmitter of the restaurant beaming promotional messages is in coverage area of the GPS receiver 604).

The present invention discloses a system and method for providing location-based advertising and location-based greeting, which allows companies to promote their products, services, and the like, and also for celebrating occasions. Systems, such as system 100 and 200 may also be referred to radio receiver based greeting card systems as they disclose greeting cards with radio receiver capabilities for providing location-based advertising and location based greeting. Further, such radio receiver based greeting card system will also be time accurate in informing the recipients about complete features of the greeting card due to the time stamp of the GPS receiver used in such systems. Furthermore, such radio receiver based greeting card systems may be manufactured at a low cost.

Also, such radio receiver based greeting card systems enable advertising party to remain in contact with the customers. Moreover, as explained in conjunctions with FIGS. 1 to 4, such radio receiver based greeting card systems arouse interest and generate curiosity in the brand or product in potential customers of the greeting cards and premiums and preclude lose of appeal to the recipients after an initial viewing, such as in the case of legacy greeting cards and advertising material.

In another embodiment, the greeting card can include a trigger having a built-in electronic timer or calendar. The trigger can be activated automatically on a pre-determined date and/or time. For example, the greeting card can play a tune on the recipients birthday. The greeting card can also play an alarm at a certain time or times, or provide an alert or tune for a pre-determined period of time based on the timer.

It will also be evident to a person skilled in the art that the though the location-based advertising and location-based greeting is provided by means of a greeting card equipped with a radio receiver, any device equipped with a radio receiver and a display may similarly be used for such purposes.

While the principles of the disclosure have been illustrated in relation to the exemplary embodiments shown herein, the principles of the disclosure are not limited thereto and include any modification, variation or permutation thereof.

What is claimed is:

1. A system of providing location-based advertising, comprising:
a greeting card having at least one surface;
a radio receiver coupled to the surface;
an information module coupled to the radio receiver; and
a power source coupled to at least one of the radio receiver and the information module.

2. The system of claim 1, wherein the radio receiver is a Global Positioning System (GPS) receiver.

3. The system of claim 1, further comprising a flexible display screen coupled to the surface.

4. The system of claim 3, wherein the flexible display screen is configured to display a promotional message.

5. The system of claim 1, further comprising a speaker.

6. The system of claim 5, wherein the speaker is configured to emit an audible promotional message.

7. The system of claim 1, wherein the power source is a photovoltaic cell.

8. The system of claim 1, wherein the power source is a rechargeable battery.

9. A method for providing location-based advertising, comprising the steps of:
transmitting to a Global Positioning System (GPS), via a radio receiver on a greeting card, a first location coordinate and an identifier;
determining, at the GPS, a second location coordinate based on the identifier;
computing, at the GPS, a route between the first location coordinate and the second location coordinate;
transmitting to the radio receiver, from the GPS, the route; and
displaying the route on a display on the greeting card.

10. The method of claim 9, further comprising the step of continually receiving an updated route from the GPS.

11. The method of claim 9, further comprising the step of displaying a message when the radio receiver is in the vicinity of the second location coordinate.

12. The method of claim 11, wherein the message is a promotional message.

13. The method of claim 11, wherein the message is a greeting.

14. The method of claim 9, further comprising the step of playing an audible message when the radio receiver is in the vicinity of the second location coordinate.

15. A system for providing location-based greeting, comprising:
a greeting card having a flexible display screen;
a Global Positioning System (GPS) receiver coupled to the greeting card, the GPS receiver communicatively coupled to a GPS;
a power source coupled to the GPS receiver; and
a speaker configured to the greeting card, the speaker configured to emit an audible message.

16. The system of claim 15, wherein the flexible display screen is configured to display location information of the greeting card.

17. The system of claim 15, wherein the flexible display screen is configured to display a video message.

18. The system of claim 17, wherein the video message is based on a signal received from the GPS.

19. The system of claim 15, wherein the audible message is a promotional message.

20. The system of claim 15, further including an electronic calendar, the electronic calendar configured to trigger the greeting card to emit the audible message or a video message upon a pre-determined date or time.
